(19) United States
(12) Patent Application Publication
(10) Pub. No.: US 2002/0068587 A1
(43) Pub. Date: Jun. 6, 2002

(54) Method and apparatus for special alert response

(76) Inventor: Robert W. Chapman, Boca Raton, FL (US)

Correspondence Address: Gregory A. Nelson, Akerman Sentertitt, 222 Lakeview Avenue, Fourth Floor, P.O. Box 3188, West Palm Beach, FL, 33402-3188, US

(21) Appl. No.: 09/728,523

(22) Filed: Dec. 1, 2000

(51) Int. Cl. H04Q 7/20

(52) U.S. Cl. 455/461; 455/456; 455/567; 342/357.1

(57) ABSTRACT

A personal subscriber unit (PSU) (100) operating in a two-way communication system (170) includes a receiver (104) and a transmitter (106) coupled to a processor (124) and a user interface (110) coupled to the processor for providing at least an alert (120) to a user of the PSU. The processor is programmed to activate a scheduled alert (202) at the PSU, calculate location data (204 or 220) from a communication system (170, 140, or 147), await a user reply (206) in response to the scheduled alert from a user of the PSU, receive a communication request (212) from a central base station controller (150) if the user reply from the user is not received, and to transmit the location data (204 or 220) to the central base station controller if there is no user reply to the communication request.

### FIELD OF THE INVENTION

This invention relates to a response communication system, and more particularly to a communication system that uses location based information for providing a response.

### BACKGROUND OF THE INVENTION

Personal communication devices such as cellular phones and pagers currently provide an array of services. Global positioning satellite (GPS) receivers and other known location finding techniques also provide positioning information that maybe useful in numerous scenarios. Many have tried to combine the information provided by these devices into a single device that would prove useful in tracking or monitoring objects and individuals. There are many instances where a user of a personal communication device could use assistance in the event of an emergency or a critical situation that may be scheduled or predetermined by the user, but such assistance would not be forthcoming for a variety of reasons. In addition to location information, other knowledge is critical for a central base station controller to have in order to provide appropriate assistance to a user of a personal subscriber unit. Thus, a need exists for a communication system that has adequate knowledge in terms of location and scheduling to provide appropriate assistance to a user of a personal subscriber unit.

### SUMMARY OF THE INVENTION

In accordance with a first aspect of the present invention, a method at a PSU of alerting and monitoring for a response from a personal subscriber unit (PSU) in a cellular communication system comprises the steps of activating a scheduled alert at the PSU, calculating location data from a communication system coupled to the PSU, and awaiting a user reply in response to the scheduled alert from a user of the PSU and receiving a communication request from a central base station controller if the user reply from the user is not received. Then, the PSU transmits the location data to the central base station controller if there is no user reply to the communication request.

In a second aspect of the present invention, a method of alerting and monitoring for a response from a PSU in a cellular communication system, comprises the steps of activating and calculating as described above and further comprises the step of awaiting a user reply in response to the scheduled alert from a user of the PSU and transmitting a communication request from a central base station controller to the PSU if the user reply from the user is not received. The method further comprises the step of transmitting the location data to the central base station controller if there is no user reply to the communication request.

In yet another aspect of the present invention, a personal subscriber unit (PSU) operating in a two-way communication system comprises a receiver and a transmitter coupled to a processor and a user interface coupled to the processor for providing at least an alert to a user of the PSU. The processor is programmed in an exemplary fashion to activate a scheduled alert at the PSU, calculate location data from a communication system, await a user reply in response to the scheduled alert from a user of the PSU, receive a communication request from a central base station controller if the user reply from the user is not received, and to transmit the location data to the central base station controller if there is no user reply to the communication request.

### BRIEF DESCRIPTION OF THE DRAWINGS

FIG. 1 is an electrical block diagram of a personal subscriber unit having an alert feature in accordance with the present invention.

FIG. 2 is an electrical block diagram of a base station controller that communicates with a personal subscriber unit having an alert feature in accordance with the present invention.

FIG. 3 is a flow chart illustrating a method of alerting and monitoring for a response from a personal subscriber unit (PSU) in accordance with the present invention.

### DETAILED DESCRIPTION OF THE DRAWINGS

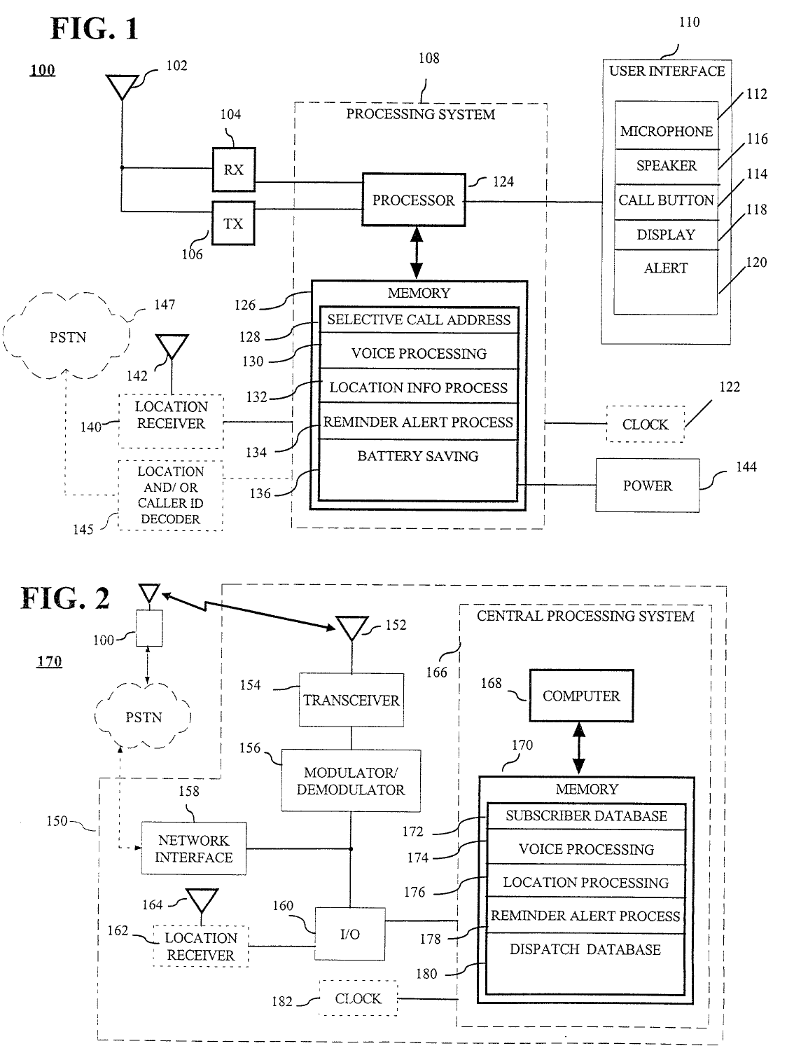

FIG. 1 is an electrical block diagram of the exemplary portable subscriber unit 100 in accordance with the present invention. The portable subscriber unit 100 comprises an antenna 102 for intercepting an outbound signal (outbound from a base station) and for transmitting an inbound signal (inbound to a base station). The antenna 102 is preferably coupled to a conventional receiver 104 for receiving the outbound signal and is coupled to a conventional transmitter 106 for transmitting the inbound signal. The receiver 104 and transmitter 106 are coupled to a processing system 108 for processing the outbound and inbound signals and for controlling the portable subscriber unit 100 in accordance with the present invention. A user interface 110 preferably is also coupled to the processing system 108 for interfacing with a user. The user interface 110 may comprise a conventional display 118 for displaying messages and other information, and a conventional alert element 120 for optionally alerting the user when an outbound signal arrives. The user interface 110 also preferably comprises a microphone 112, an activation button 114, and a speaker 116. A conventional clock 122 is optionally coupled to the processing system 108 for supporting time keeping requirements of the portable subscriber unit 100. Of course, timing information could be obtained in other alternative ways including use of cellular system timing or use of GPS synchronization timing signals for example as may be become apparent from the description below.

The processing system 108 comprises a conventional processor 124 and a conventional memory 126. The memory 126 preferably comprises software elements and data for programming the processing system 108 in accordance with the present invention. The memory 126 preferably includes a selective call address 128 to which the portable subscriber unit 100 is responsive. In addition, the memory 126 includes a voice call processing element 130 for programming the processing system 108 to process voice calls through well-known techniques. The memory 126 further comprises a location information processing program 132 for programming the processing system 108 to process location information in accordance with the present invention. The location information can be obtained in a number of known ways including triangulation of terrestrial signals (preferably from a cellular communication system), time of arrival and angle of arrival techniques or use of GPS information from a separate location receiver 140 having antenna 142 as shown. Alternatively, location information can be derived from a hardwired source such as a telephone network such as a public switched telephone network (PSTN) 147 using the SS7 protocol (for example) that provides for caller identification information as is well known. This option is available of course only if the PSU 100 is coupled to the PSTN 147 via a location and/or caller identification decoder unit 145. The memory 126 further comprises a reminder alert process 134 for storing scheduling information and possible synchronization information. The reminder alert process 134 could use the external clock 122 or potentially use the timing information from a GPS receiver (140). The memory 126 also ideally includes a battery saving routine that would be coupled to a power source 144 for efficiently using the power supplied.

FIG. 2 is an electrical block diagram depicting an exemplary controller 150 in accordance with the present invention operating in conjunction with at least one portable subscriber unit 100 in a communication system 170. The controller 150 comprises a network interface 158 for receiving voice or data from an originator via a network (not shown). The network interface 158 is coupled to a processing system 166 for controlling and communicating with the network interface 158. The processing system is coupled to a base station interface or input/output interface 160 for controlling and communicating with the base stations which can comprise an antenna 152 coupled to a transceiver 154 and a modulator/demodulator unit 156 for example. The processing system may be coupled to other base stations via the interfaces 160 and 158. The processing system 150 is also optionally coupled to a conventional clock 182 for providing a timing signal to the processing system 150. The processing system 150 comprises a conventional computer 168 and a conventional memory 170 programmed with information and operating software in accordance with the present invention. The memory 170 comprises a conventional subscriber database 172 for storing profiles defining service for subscribers using the system. The memory 170 further comprises a voice processing element 174 for processing voice through well-known techniques and a location data processing element 176 for processing location data through well-known techniques. Further, the memory 170 may contain a reminder alert program that would remind subscribers in the subscriber database of predetermined events as desired. Finally, the memory 170 may also comprise a dispatch database to provide immediate assistance to subscribers requiring such help.

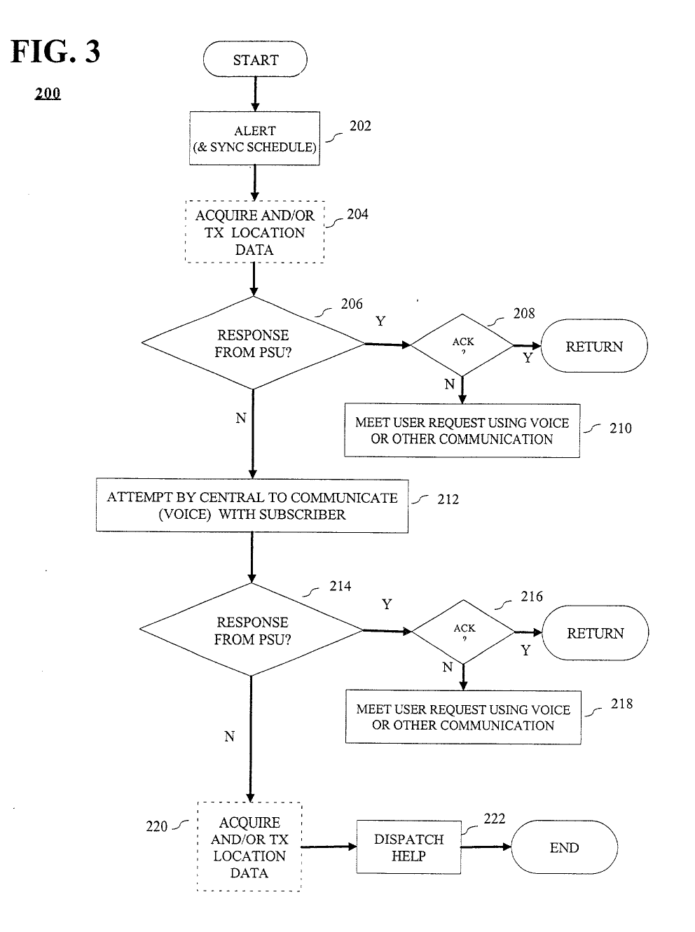

Referring to FIG. 3, a flow chart illustrating a method 200 of alerting and monitoring for a response from a personal subscriber unit (PSU) in a cellular communication system is shown. The method 200 preferably comprises the steps at the PSU of activating a scheduled alert at the PSU at step 202. The step 202 can be achieved in various ways including receiving a signal from a central base station controller that was programmed at the user's request. Alternatively, a user of the PSU could input schedule data into the PSU including reminder alert information and the PSU would synchronize the schedule data with the central base station controller such that the PSU itself provides the scheduled alert without requiring a signal from the central base station controller. In other words, the PSU and central base station controller preferably maintain a synchronized schedule between themselves. Next, at step 204, the method optionally calculates or obtains location data from the cellular communication system and optionally transmits it to a central base station controller. The calculation step can comprise receiving GPS location data at the PSU, estimating location information from multiple signals received at the PSU as is known in the location art including triangulation, time of arrival, and angle of arrival techniques among others. The calculation step could also comprise the step of extracting caller ID signals from a telephone network when the PSU is coupled to the telephone network. At decision block 206, the method 200 is awaiting a user reply in response to the scheduled alert from a user of the PSU for a predetermined amount of time. The reply could be a signal resulting from the activation of a button on the PSU by the user or a signal resulting from voice activation by an audible reply by the user at the PSU among other types of replies from the user. If a reply is received, at decision block 208 it is determined if an acknowledgement is received. If an acknowledgement is received at decision block 208, then the method returns to normal processing. If the response is something other than an acknowledgement, then the communication system will need to meet the user's request using voice or some other form of communication at step 210. If no response is received at decision block 206 within the predetermined amount of time, then the PSU will receive a communication request from a central base station controller. Again, at decision block 214, the method 200 is awaiting a user reply in response to the communication request from the central base station controller for a predetermined amount of time. If a reply is received, at decision block 216 it is determined if an acknowledgement is received. If an acknowledgement is received at decision block 216, then the method returns to normal processing. If the response is something other than an acknowledgement, then the communication system will need to meet the user's request using voice or some other form of communication at step 218. If no response is received at decision block 214 from the user within a predetermined amount of time, then the method may optionally acquire and/or transmit location data (particularly if not already done at step 204) to the central base station controller. Note that if the PSU is coupled to a hardwired telephone network as well, the PSU can transmit the location data to the central base station via the PSTN and network interface 158 as shown in FIG. 2. The central base station controller can then dispatch help to the PSU user at step 222 using the location data obtained from the PSU.

While particular embodiments of the present invention have been described herein, it should be understood that other embodiments could be interpreted as being within the scope of the present invention.

We claim:

1. A method of alerting and monitoring for a response from a personal subscriber unit (PSU) in a cellular communication system, comprising the steps at the PSU of:
activating a scheduled alert at the PSU;
calculating location data from a communication system coupled to the PSU;
awaiting a user reply in response to the scheduled alert from a user of the PSU for a predetermined amount of time and receiving a communication request from a central base station controller if the user reply from the user is not received within the predetermined amount of time;
transmitting the location data to the central base station controller if there is no user reply to the communication request.

2. The method of claim 1, wherein the step of calculating location data comprises the step of receiving GPS location data at the PSU.

3. The method of claim 1, wherein the step of calculating location data comprises the step of estimating location data from multiple signals received at the PSU from the cellular communication system.

4. The method of claim 1, wherein the step of calculating location data further comprises the step of obtaining location data from a telephone network coupled to the PSU.

5. The method of claim 1, wherein the step of activating a scheduled alert comprises the step of receiving a signal from the central base station controller.

6. The method of claim 1, wherein the step of activating a scheduled alert comprises the step of inputting schedule data into the PSU and synchronizing the schedule data with the central base station controller such that the PSU provides the scheduled alert without requiring a signal from the central base station controller.

7. The method of claim 1, wherein the step of awaiting a user reply comprises awaiting a signal resulting from the activation of a button on the PSU by the user.

8. The method of claim 1, wherein the step of awaiting a user reply comprises a signal resulting from voice activation by a audible reply by the user at the PSU.

9. A method of alerting and monitoring for a response from a personal subscriber unit (PSU) in a cellular communication system, comprising the steps of:
activating a scheduled alert at the PSU;
calculating location data from a communication system;
awaiting a user reply in response to the scheduled alert from a user of the PSU for a predetermined amount of time and transmitting a communication request from a central base station controller to the PSU if the user reply from the user is not received within the predetermined amount of time; and
transmitting the location data to the central base station controller if there is no user reply to the communication request.

10. The method of claim 9, wherein the communication system is selected from the group comprising a global position satellite system, the cellular communication system, or a telephone network and wherein the step of calculating the location data comprises the step selected from the respective group of steps of receiving GPS location data at the PSU, estimating location data from multiple signals received at the PSU from the cellular communication system, or extracting location data from the telephone network when the PSU is coupled to the telephone network.

11. The method of claim 9, wherein the method further comprises the step of dispatching assistance to the user of the PSU at the location determined from the location data.

12. The method of claim 9, wherein the method further comprises the step of maintaining a synchronized schedule between the central base station controller and the PSU.

13. A personal subscriber unit (PSU) operating in a two-way communication system, comprising:
a receiver and a transmitter coupled to a processor; and
a user interface coupled to the processor for providing at least an alert to a user of the PSU, wherein the processor is programmed to:
activate a scheduled alert at the PSU;
calculate location data from a communication system;
await a user reply in response to the scheduled alert from a user of the PSU for a predetermined amount of time and receive a communication request from a central base station controller if the user reply from the user is not received within the predetermined amount of time;
transmit the location data to the central base station controller if there is no user reply to the communication request.

14. The PSU of claim 13, wherein the PSU further comprises a GPS receiver for receiving signals providing the location data.

15. The PSU of claim 14, wherein the communication system is selected from the group comprising a global position satellite system, the two-way communication system, or a telephone network and wherein the step of calculating the location data comprises the step selected from the respective group of steps of receiving GPS location data at the PSU, estimating location data from multiple signals received at the PSU from the cellular communication system, or extracting location data from the telephone network when the PSU is coupled to the telephone network.

16. The PSU of claim 13, wherein the processor activates a scheduled alert by receiving a signal from the central base station controller.

17. The PSU of claim 13, wherein the processor activates a scheduled alert by inputting schedule data into the PSU and synchronizing the schedule data with the central base station controller such that the PSU provides the scheduled alert without requiring a signal from the central base station controller.

18. The PSU of claim 13, wherein the processor is further programmed to await the user reply by receiving a signal resulting from the activation of a button on the PSU by the user.

19. The PSU of claim 13, wherein the processor is further programmed to await for the user reply in the form of a signal resulting from voice activation by a audible reply by the user at the PSU.

20. The PSU of claim 15, wherein the processor is further programmed to transmit location data to the central base station controller using either the two-way communication system or the telephone network when the PSU is coupled to the telephone network.
